(19) United States
(12) Patent Application Publication
(10) Pub. No.: US 2015/0021087 A1
(43) Pub. Date: Jan. 22, 2015

(54) Self Contained Pre-Wired Device

(71) Applicant: Glenn A. EHRGOTT, Flanders, NJ (US)

(72) Inventor: Glenn A. EHRGOTT, Flanders, NJ (US)

(21) Appl. No.: 13/943,048

(22) Filed: Jul. 16, 2013

(51) Int. Cl. H02G 3/16; H02G 3/08

(52) U.S. Cl. CPC H02G 3/16; H02G 3/083
USPC 174/541

(57) ABSTRACT

A self contained prewired device includes a housing, at least one input port, and at least one access port. The housing is provided with a mounting plate, a lateral wall, and an insertion wall. The mounting plate and the insertion wall are connected with the lateral wall from each extremity, where the mounting plate and the insertion wall are oppositely positioned from each other. The at least one input port is positioned on the mounting plate, and the at least one access port is positioned on the insertion wall. The at least one input port and the at least one access port respectively allow electricity and data to transport from one location to another as the at least one input port and the at least one access port are either electrically or electronically connected to each other.

### FIELD OF THE INVENTION

The present invention relates generally to electrical and data connection devices. More specifically the present invention is a self contained prewired device which allows electrical wirings or data cables to connect through a structural wall.

### BACKGROUND OF THE INVENTION

Electrical wires and data cables normally associate with many different structural elements, such as trailer walls, recreational vehicles, buses, trucks, home exterior walls, home interior walls, and office dividers, as the electricity is transported through the electrical wires and the data is transported through the data cables. All of the electrical wires and the data cables are normally installed during the construction process of the structural elements. In some instances, additional electrical wires and/or data cables are required in order to compensate for expanding usage or ongoing problems after the construction process is completed. In these situations, the electrical wires and/or data cables may be placed around structural walls so that the electricity or data can be transported from one location to another, where these additions create installation cost and component cost. For example, in emergency situations, externally positioned electrical generator can provide electricity to residential and commercial buildings as extension wires carry the electricity from the externally positioned generator to the inside of the buildings. In most situations, the extension wires are positioned through window or door openings, leaving the respective doors or windows open, creating an unsafe environment. The Same example can be related to trailers and other type of automobiles.

It is therefore an objective of the present invention to introduce a self contained prewired device which can be installed within the structural walls so that the electricity or data can be transported from one location to another utilizing the shortest path. The thickness of the present invention correlates with the thickness of the structural wall so that better positioning can be achieved within the structural walls. The present invention also provides easy installation steps, where the installation steps provide cleaner and faster installation of the present invention.

### BRIEF DESCRIPTION OF THE DRAWINGS

FIG. 1 is a front perspective view of the first embodiment of the present invention in first configuration.

FIG. 2 is a back perspective view of the first embodiment of the present invention in first configuration.

FIG. 3 is a front view of the first embodiment of the present invention in first configuration.

FIG. 4 is a back view of the first embodiment of the present invention in first configuration.

FIG. 5 is a front view of the first embodiment of the present invention in first configuration, showing the plane upon which a cross sectional view is shown in FIG. 6.

FIG. 6 is a cross section view of the first embodiment of the present invention in first configuration taken along line A-A of FIG. 5.

FIG. 7 is a front perspective view of a second configuration of the present invention.

FIG. 8 is a back perspective view of the second configuration of the present invention.

FIG. 9 is a front view of the second configuration of the present invention, showing the plane upon which a cross sectional view is shown in FIG. 10.

FIG. 10 is a cross section view of the second configuration of the present invention taken along line A-A of FIG. 9.

FIG. 11 is a front perspective view of a third configuration of the present invention.

FIG. 12 is a back perspective view of the third configuration of the present invention.

FIG. 13 is a front view of the third configuration of the present invention, showing the plane upon which a cross sectional view is shown in FIG. 14.

FIG. 14 is a cross section view of the third configuration of the present invention taken along line A-A of FIG. 13.

FIG. 15 is a block diagram illustrating the electrical connection of the first embodiment of the present invention.

FIG. 16 is a front view of the second embodiment of the present invention in first configuration.

FIG. 17 is a back view of the second embodiment of the present invention in first configuration.

FIG. 18 is a block diagram illustrating the electronic connection of the second embodiment of the present invention.

### DETAIL DESCRIPTIONS OF THE INVENTION

All illustrations of the drawings are for the purpose of describing selected versions of the present invention and are not intended to limit the scope of the present invention.

The present invention is a self contained pre-wired apparatus which comprises a housing 1, at least one input port 6, and at least one access port 12. The present invention is designed to fit though structural walls with a simple installation process so that electricity or data can be transported through the present invention. Due to the configuration and the simple installation process of the present invention, the present invention provides solutions for wiring through a structural wall without using two separate junction boxes and wiring around the structural wall with extension cords or exposed wiring.

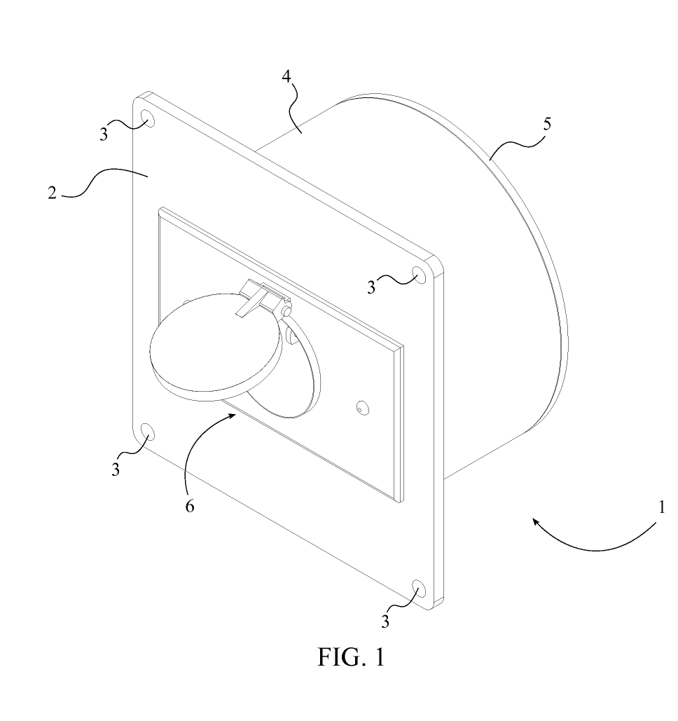

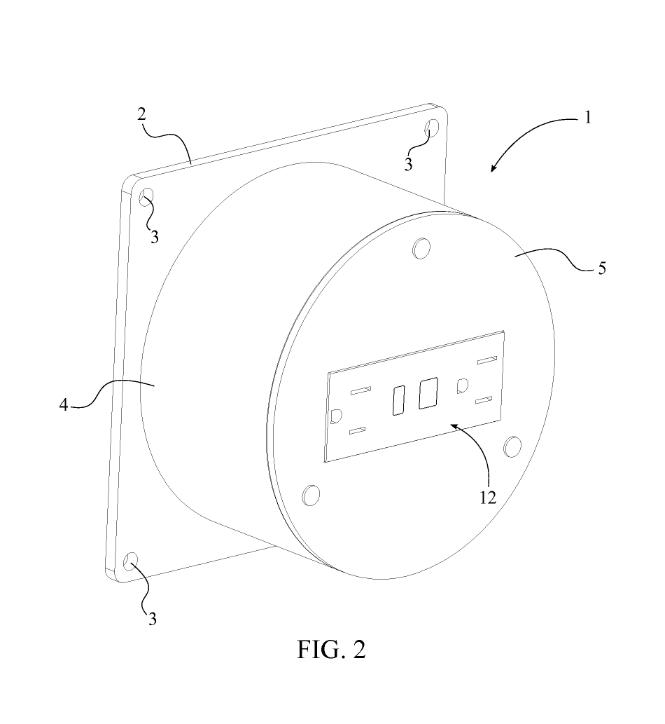

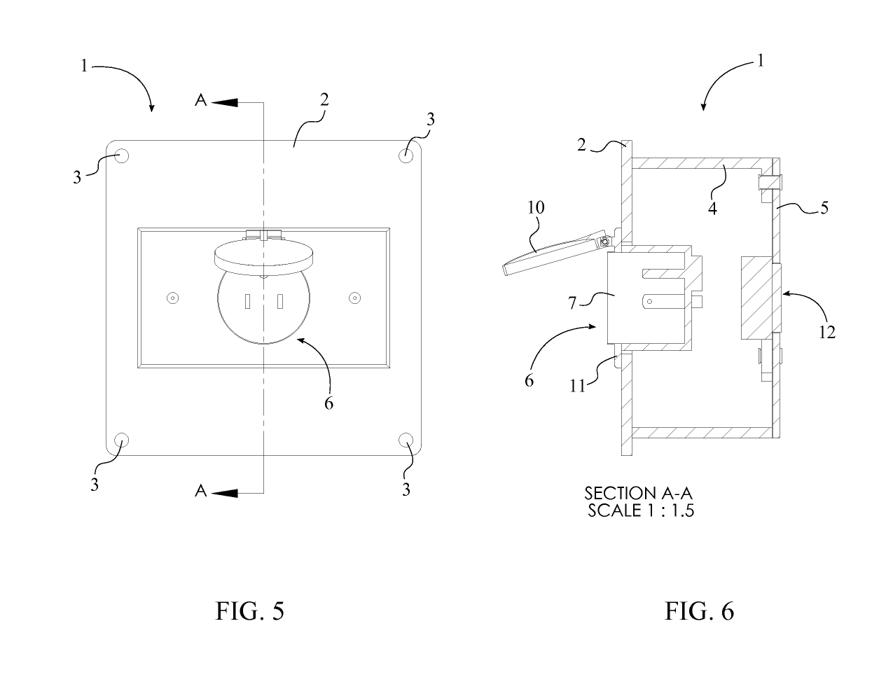

In a first configuration of the present invention, the housing 1 which functions as the main body for the present invention comprises a mounting plate 2, a lateral wall 4, and an insertion wall 5. In reference to FIG. 1 and FIG. 2, the mounting plate 2 and the insertion wall 5 are concentrically connected with the lateral wall 4 at each extremity, where the mounting plate 2 is oppositely positioned from the insertion wall 5 along the lateral wall 4. The lateral wall 4 of the present invention is preferably made into a cylindrical shape, but is not limited only to the cylindrical shape and can be any other geometric or organic shapes. As shown in FIG. 5 and FIG. 6, the insertion wall 5 is positioned flush with the lateral wall 4 from one extremity, where the insertion wall 5 and the lateral wall 4 comprise the same shape. For example, if the lateral wall 4 is circular and the diameter of the lateral wall 4 is 5 inches, the insertion wall 5 is also circular and the diameter of the insertion wall 5 is 5 inch. The mounting plate 2 of the present invention is preferably made into a square or rectangular shape but can also be any other geometric or organic shapes. The parameter of the mounting plate 2 is larger than the parameter of the lateral wall 4. For example, if the lateral wall 4 and the mounting plate 2 both comprise a circular shape, the mounting plate 2 has a larger diameter than the lateral wall 4 so that the parameter of the mounting plate 2 becomes larger than the lateral wall 4. If the lateral wall 4 comprises a circular shape and the mounting plate 2 comprises a rectangular shape, the smallest side dimension of the mounting plate 2 is larger than the diameter of the lateral wall 4 so that the parameter of the mounting plate 2 becomes larger than the lateral wall 4.

As shown in FIG. 1 and FIG. 5, the mounting plate 2 comprises at least one wall attachment 3, where the at least one wall attachment 3 secures the housing 1 with the structural wall. The at least one wall attachment 3 of the first configuration of the present invention can include, but is not limited to, at least one attachment hole, at least one peel and stick adhesive strip, adhesive materials applied by the installer. The at least one wall attachment 3 is positioned on the mounting plate 2 but the placement of the at least one wall attachment 3 can differ depending on the type of at least one wall attachment 3. For example, if the at least one wall attachment 3 is the at least one attachment hole, the at least one attachment hole traverses through the mounting plate 2.

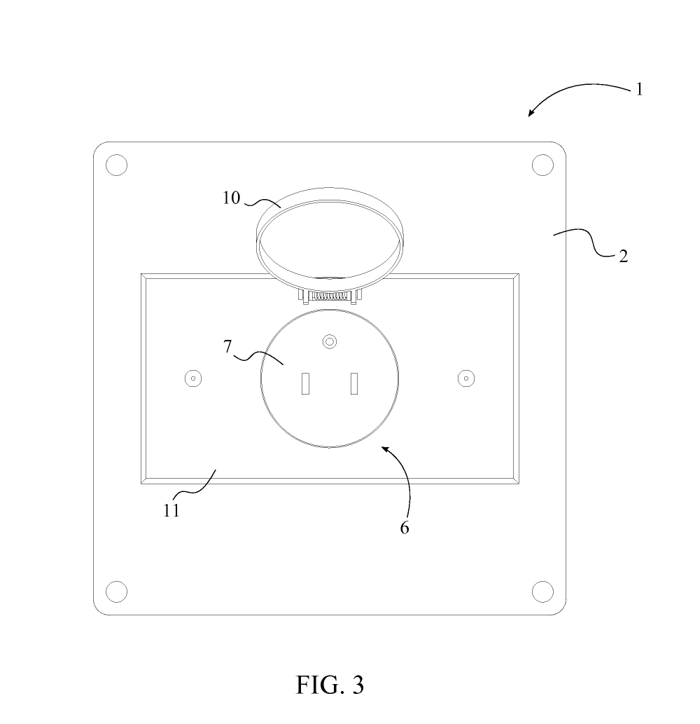

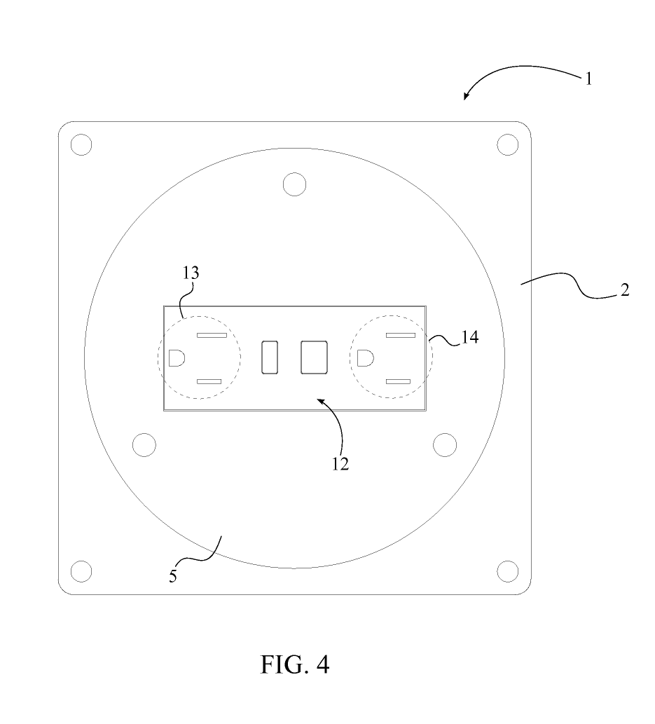

In reference to FIG. 3 and FIG. 4, the at least one input port 6 is traversed through the mounting plate 2 and attached onto the mounting plate 2, and the at least one access port 12 is traversed through the insertion wall 5 and attached onto the insertion wall 5. Depending on different embodiments of the present invention, the at least one input port 6 and the at least one access port 12 are either electrically or electronically connected to each other within the housing 1. The at least one access port 12 may also electrically connect with optional indicator lights, optional circuit breakers, and optional fuses for added functionality of the present invention. Even though the at least one input port 6 and the at least one access port 12 are respectively attached with the mounting plate 2 and the insertion wall 5 in the first configuration of the present invention, the at least one input port 6 and the at least one access port 12 can also respectively attached with the insertion wall 5 and mounting plate 2.

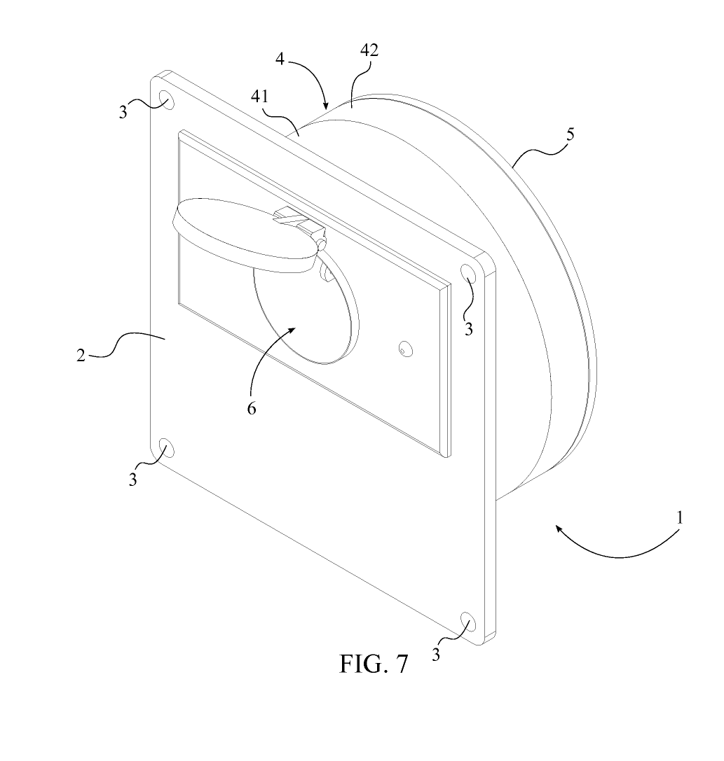

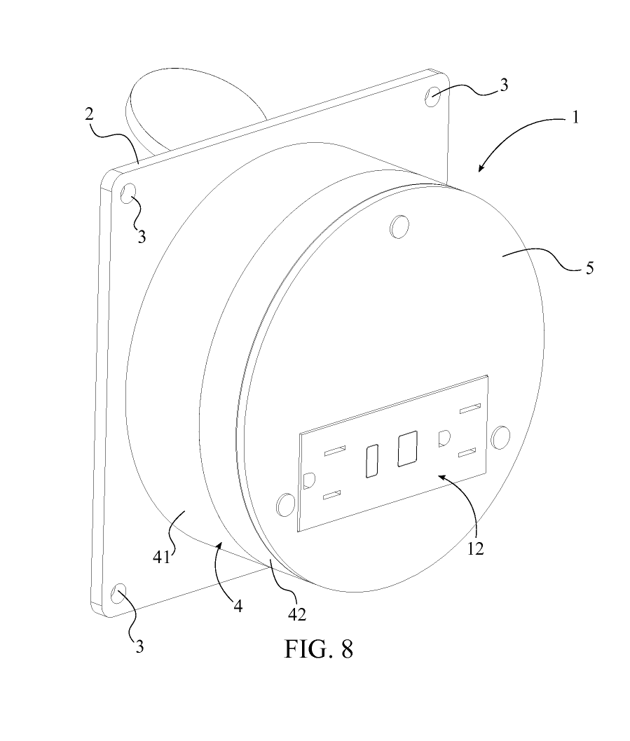

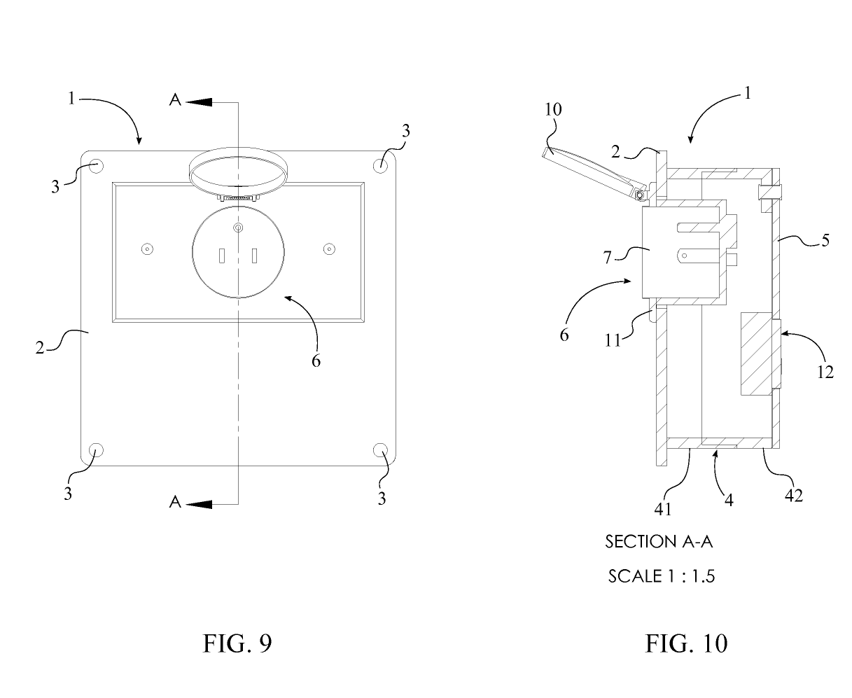

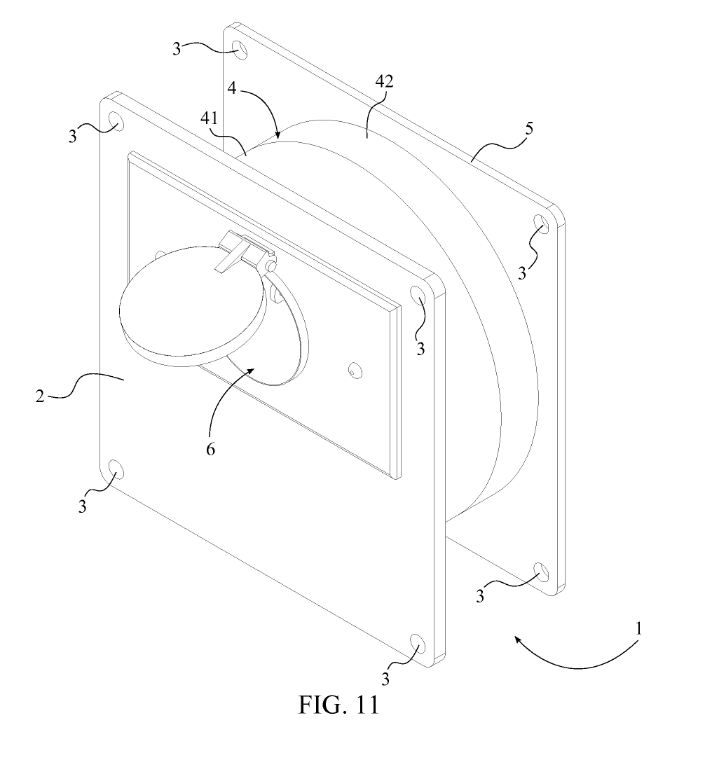

In a second configuration of the present invention, the housing 1 which functions as the main body for the present invention comprises the mounting plate 2, the lateral wall 4, and the insertion wall 5. The lateral wall 4 comprises an outer portion 41 and an inner portion 42. The outer portion 41 and the inner portion 42 are telescopically sleeved with each other in such way that the attachment of the inner portion 42 and the outer portion 41 completes the lateral wall 4. In reference to FIG. 7 and FIG. 8, the mounting plate 2 is concentrically connected with the outer portion 41, and the insertion wall 5 is concentrically connected with the inner portion 42. Since the inner portion 42 and the outer portion 41 complete the lateral wall 4, the mounting plate 2 is oppositely positioned from the insertion wall 5 along the lateral wall 4. More specifically, the outer portion 41 and the inner portion 42 are adjacently positioned with each other in between the mounting plate 2 and the insertion wall 5. The lateral wall 4 of the present invention is preferably made into a cylindrical shape, but is not limited only to the cylindrical shape and can be any other geometric or organic shapes. As shown in FIG. 9 and FIG. 10, the insertion wall 5 is positioned flush with the inner portion 42 from one extremity, where the insertion wall 5 and the inner portion 42 comprise the same shape. For example, if the inner portion 42 is circular and the diameter of the inner portion 42 is 5 inches, the insertion wall 5 is also circular and the diameter of the insertion wall 5 is 5 inch. The mounting plate 2 of the present invention is preferably made into a square or rectangular shape but can also be any other geometric or organic shapes. The parameter of the mounting plate 2 is larger than the parameter of the outer portion 41. For example, if the outer portion 41 and the mounting plate 2 both comprise a circular shape, the mounting plate 2 has a larger diameter than the outer portion 41 so that the parameter of the mounting plate 2 becomes larger than the outer portion 41. If the outer portion 41 comprises a circular shape and the mounting plate 2 comprises a rectangular shape, the smallest side dimension of the mounting plate 2 is larger than the diameter of the outer portion 41 so that the parameter of the mounting plate 2 becomes larger than the outer portion 41.

As shown in FIG. 8, the mounting plate 2 comprises the at least one wall attachment 3, where the at least one wall attachment 3 secures the housing 1 with the structural wall. The at least one wall attachment 3 of the second configuration of the present invention can include, but is not limited to, at least one attachment hole, at least one peel and stick adhesive strip, adhesive materials applied by the installer. The at least one wall attachment 3 is positioned on the mounting plate 2 but the placement of the at least one wall attachment 3 can differ depending on the type of at least one wall attachment 3. For example, if the at least one wall attachment 3 is the at least one peel and stick adhesive strip, the at least one peel and stick adhesive strip is adjacently positioned with the lateral wall 4.

In reference to FIG. 7 and FIG. 8, the at least one input port 6 is traversed through the mounting plate 2 and attached onto the mounting plate 2, and the at least one access port 12 is traversed through the insertion wall 5 and attached onto the insertion wall 5. Depending on different embodiments of the present invention, the at least one input port 6 and the at least one access port 12 are either electrically or electronically connected to each other within the housing 1. The at least one access port 12 may also electrically connect with optional indicator lights, optional circuit breakers, and optional fuses for added functionality of the present invention. Even though the at least one input port 6 and the at least one access port 12 are respectively attached with the mounting plate 2 and the insertion wall 5 in the second configuration of the present invention, the at least one input port 6 and the at least one access port 12 can also respectively attached with the insertion wall 5 and mounting plate 2.

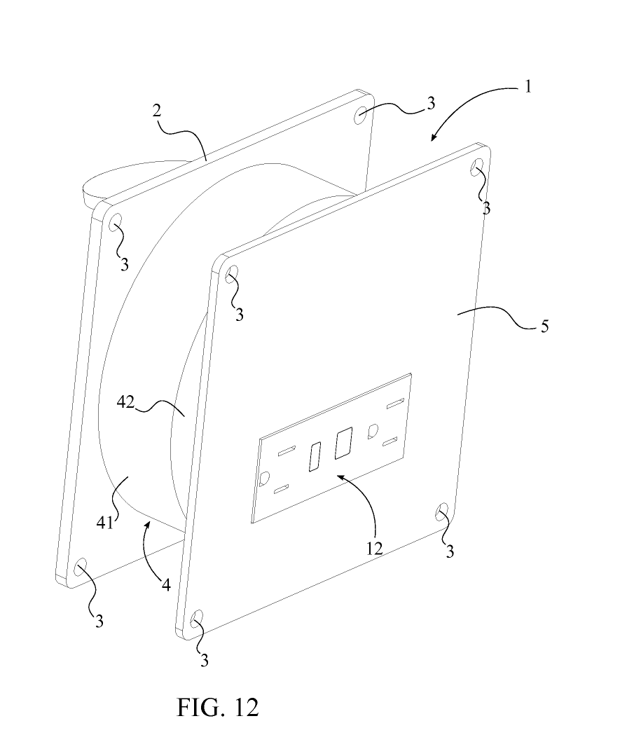

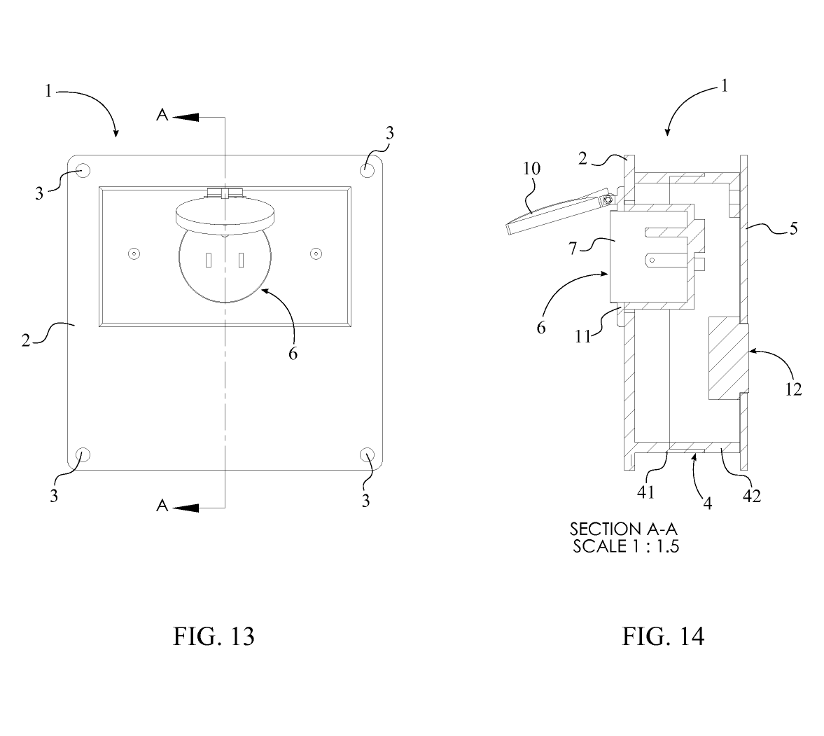

In a third configuration of the present invention, the housing 1 which functions as the main body for the present invention comprises the mounting plate 2, the lateral wall 4, and the insertion wall 5. The lateral wall 4 comprises an outer portion 41 and an inner portion 42. The outer portion 41 and the inner portion 42 are telescopically sleeved with each other in such way that the attachment of the inner portion 42 and the outer portion 41 completes the lateral wall 4. In reference to FIG. 11 and FIG. 12, the mounting plate 2 is concentrically connected with the outer portion 41, and the insertion wall 5 is concentrically connected with the inner portion 42. Since the inner portion 42 and the outer portion 41 complete the lateral wall 4, the mounting plate 2 is oppositely positioned from the insertion wall 5 along the lateral wall 4. More specifically, the outer portion 41 and the inner portion 42 are adjacently positioned with each other in between the mounting plate 2 and the insertion wall 5. The lateral wall 4 of the present invention is preferably made into a cylindrical shape, but is not limited only to the cylindrical shape and can be any other geometric or organic shapes. As shown in FIG. 13 and FIG. 14, the parameter of the insertion wall 5 is larger than parameter of the inner portion 42, where the insertion wall 5 and the inner portion 42 comprise similar shapes or different shapes. For example, if the inner portion 42 is circular and the diameter of the inner portion 42 is 5 inches, the insertion wall 5 can also be circular but the diameter of the insertion wall 5 is more than 5 inch. The mounting plate 2 of the present invention is preferably made into a square or rectangular shape but can also be any other geometric or organic shapes. The parameter of the mounting plate 2 is larger than the parameter of the outer portion 41. For example, if the outer portion 41 and the mounting plate 2 both comprise a circular shape, the mounting plate 2 has a larger diameter than the outer portion 41 so that the parameter of the mounting plate 2 becomes larger than the outer portion 41. If the outer portion 41 comprises a circular shape and the mounting plate 2 comprises a rectangular shape, the smallest side dimension of the mounting plate 2 is larger than the diameter of the outer portion 41 so that the parameter of the mounting plate 2 becomes larger than the outer portion 41.

As shown in FIG. 12, the mounting plate 2 and the insertion wall 5 each comprises the at least one wall attachment 3, where the at least one wall attachment 3 secures the housing 1 with the structural wall. More specifically, the at least one wall attachment 3 of the mounting plate 2 is positioned on the mounting plate 2 and secures the outer portion 41 and the mounting plate 2 with the structural wall. Similarly, the at least one wall attachment 3 of the insertion wall 5 is positioned on the insertion wall 5 and secures the inner portion 42 and the insertion wall 5 with the structural wall opposite from the outer portion 41. The at least one wall attachment 3 of the third configuration of the present invention can include, but is not limited to, at least one attachment hole, at least one peel and stick adhesive strip, adhesive materials applied by the installer.

In reference to FIG. 11 and FIG. 12, the at least one input port 6 is traversed through the mounting plate 2 and attached onto the mounting plate 2, and the at least one access port 12 is traversed through the insertion wall 5 and attached onto the insertion wall 5. Depending on different embodiments of the present invention, the at least one input port 6 and the at least one access port 12 are either electrically or electronically connected to each other within the housing 1. The at least one access port 12 may also electrically connect with optional indicator lights, optional circuit breakers, and optional fuses for added functionality of the present invention. Even though the at least one input port 6 and the at least one access port 12 are respectively attached with the mounting plate 2 and the insertion wall 5 in the third configuration of the present invention, the at least one input port 6 and the at least one access port 12 can also respectively attached with the insertion wall 5 and mounting plate 2.

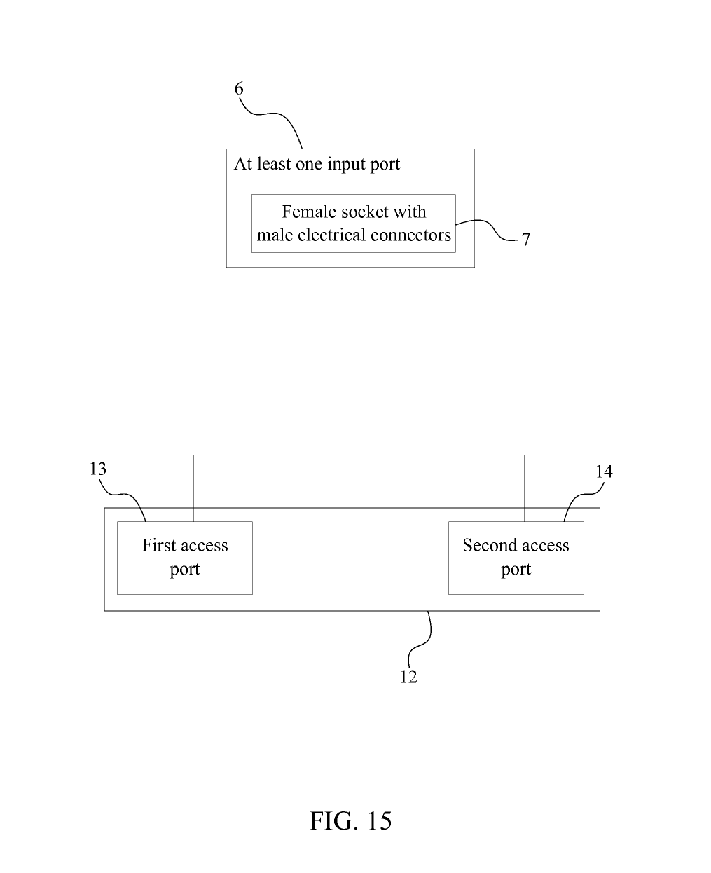

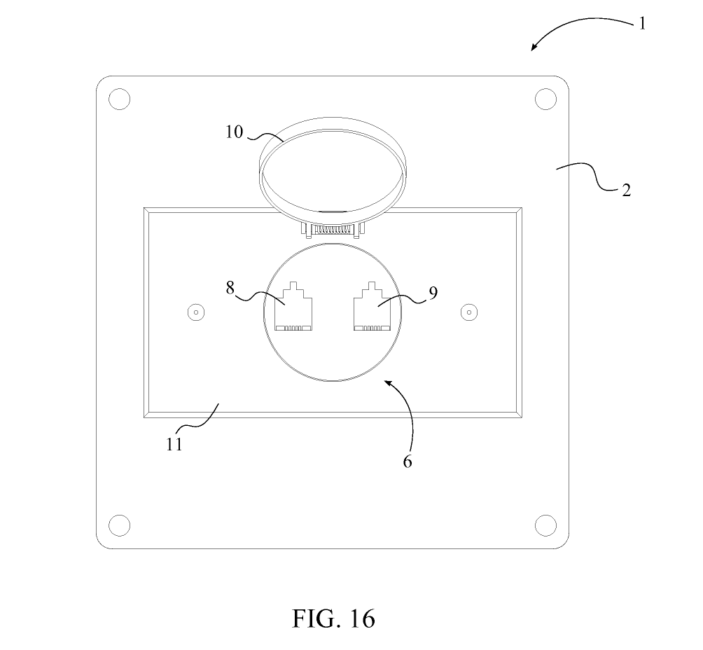

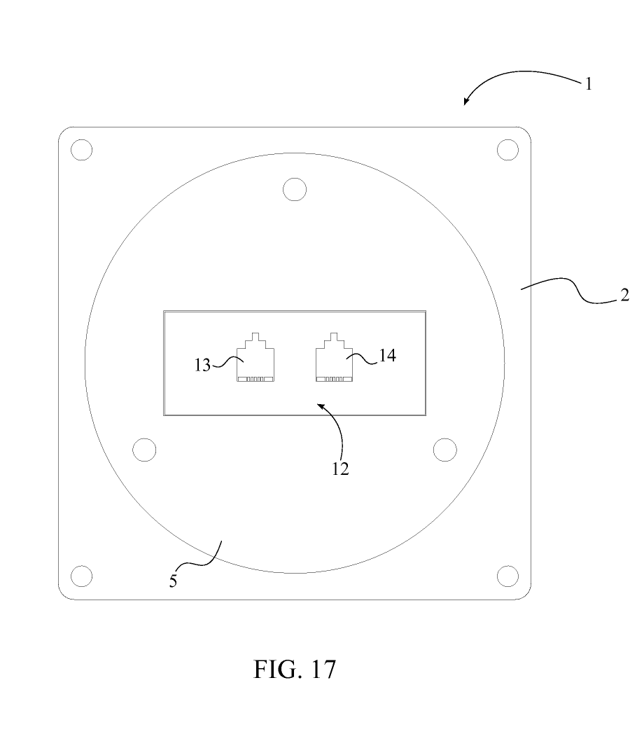

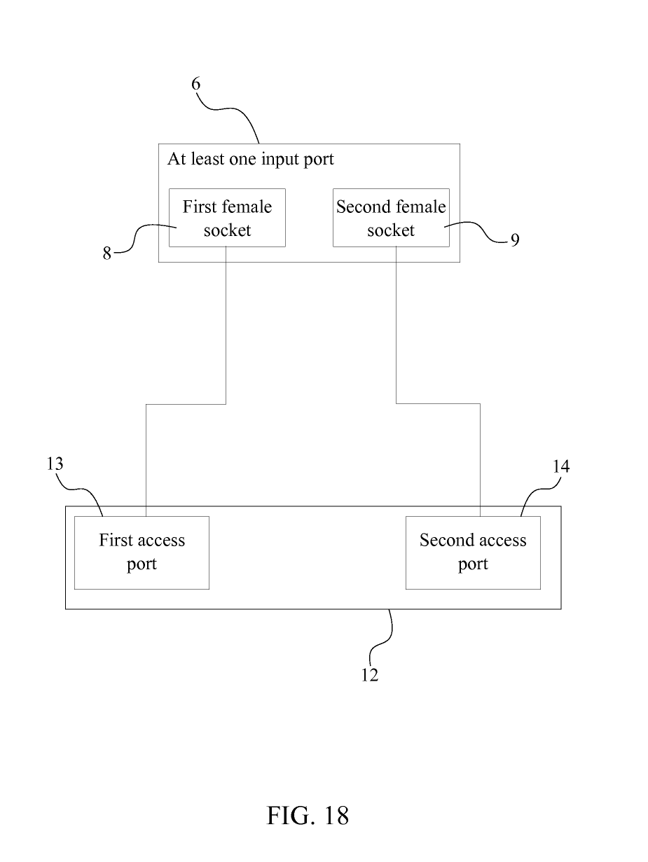

In reference to FIG. 1-FIG. 15, in a first embodiment of the first configuration, the second configuration, and the third configuration of the present invention, the at least one input port 6 comprises a female socket with male electrical connectors 7, a protective cap 10, and an attachment plate 11. The attachment plate 11 is connected onto the mounting plate 2, where the attachment plate 11 provides a foundation for the female socket with male electrical connectors 7 and the protective cap 10. The female socket with male electrical connectors 7 is connected with the attachment plate 11 and extended into the housing 1. The female socket with male electrical connectors 7 of the first embodiment is an electric current receiver socket with a male type electrical connectors which accepts the end of a common electric extension cord, where the female socket with male electrical connectors 7 includes, but is not limited to, standard male type 3 prong, 4 prong twist lock type input plug, and male type 2 prong. The protective cap 10 is attached onto the female socket with male electrical connectors 7 and positioned atop the female socket with male electrical connectors 7, where the protective cap 10 may pivotally connect with the attachment plate 11 or removably attach with the female socket with male electrical connectors 7. When the protective cap 10 is pivotally connected with the attachment plate 11, the protective cap 10 pivots in between an open position and a close position, where the open position of the protective cap 10 provides access to the female socket with male electrical connectors 7 and the close position restricts access to the female socket with male electrical connectors 7. The protective cap 10 is either positioned above the common electric extension cord in the open position or completely removed from the female socket with male electrical connectors 7, when an end of the common electric extension cord is inserted into the female socket with male electrical connectors 7. The protective cap 10 provides protection to the female socket with male electrical connectors 7 and the connection of the common electric extension cord from outside elements such as water, insects, and falling objects. In the first embodiment, the at least one access port 12 comprises a first access port 13 and a second access port 14. The female socket with male electrical connectors 7 is electrically connected with the first access port 13 and the second access port 14 so that the electric power from the female socket with male electrical connectors 7 can be individually transported into the first access port 13 and the second access port 14. The at least one access port 12 of the first embodiment can be any type power outlet, such as 110 volt power out, 220 volt power outlet, 240 volt power outlet, and 12 volt power outlet. In reference to FIG. 16, FIG. 17, and FIG. 18, in a second embodiment of the first configuration, the second configuration, and the third configuration of the present invention, the at least one input port 6 comprises a first female socket 8, a second female socket 9, the protective cap 10, and the attachment plate 11. The attachment plate 11 is connected onto the mounting plate 2, where the attachment plate 11 provides a foundation for the first female socket 8, the second female socket 9, and the protective cap 10. The first female socket 8 and the second female socket 9 are connected with the attachment plate 11 and extended into the housing 1. The first female socket 8 and the second female socket 9 of the second embodiment are data ports which accept data cable ends, where the first female socket 8 and the second female socket 9 include, but are not limited to, registered jack ports, serial ports, and USB ports. The protective cap 10 is attached onto first female socket 8 and the second female socket 9 and positioned atop the first female socket 8 and the second female socket 9, where the protective cap 10 may pivotally connect with the attachment plate 11 or removably attach with the first female socket 8 and the second female socket 9. When the protective cap 10 is pivotally connected with the attachment plate 11, the protective cap 10 pivots in between an open position and a close position, where the open position of the protective cap 10 provides access to the first female socket 8 and the second female socket 9 and the close position restricts access to the first female socket 8 and the second female socket 9. The protective cap 10 is either positioned above the common data cable in the open position or completely removed from the first female socket 8 and the second female socket 9, when an end of the common data cable is inserted into either the first female socket 8 or the second female socket 9. The protective cap 10 provides protection to the first female socket 8 and the second female socket 9 and the connection of the common data cable from outside elements such as water, insects, and falling objects. In the second embodiment, the at least one access port 12 comprises a first access port 13 and a second access port 14, where the first access port 13 and the second access port 14 preferably accommodate a plurality of female connectors. The first female socket 8 is electronically connected with the first access port 13 so that data from the first female socket 8 can be transported into the first access port 13. Similarly, the second female socket 9 is electronically connected with the second access port 14 so that data from the second female socket 9 can be transported into the second access port 14. The first access port 13 and the second access port 14 of the second embodiment can be any type of data ports, include, but are not limited to, registered jack ports, serial ports, and USB ports.

As shown in FIG. 6 and FIG. 10, In order to compensate for the size of the at least one input port 6 and at least one access port 12, the at least one input port 6 and the at least one access port 12 can either linearly positioned with each other or can be offset from each other within the housing 1.

In order to install the first configuration of the present invention with a structural wall, a hole needs to be cut out from the structural wall as the first step, where the shape of the hole is determined by the shape of the lateral wall 4 of the housing 1. For example, if the shape of the lateral wall 4 of the housing 1 is circular, a circular hole is cut through the structural wall. Then the housing 1 is inserted into the hole in such way that the insertion wall 5 is traversed through the hole until the mounting plate 2 is adjacently positioned with the structural wall. The length of the lateral wall 4 from one extremity to opposite extremity depends on the thickness of the structural wall as the lateral wall 4 completely positions within the structural wall and the lateral wall 4 adjacently positioned with the hole during installation. Then the at least one wall attachment 3 is used to secure the first configuration of the present invention with the structural wall. In order to install the second configuration of the present invention, the outer portion 41 and the inner portion 42 are telescopically sleeved into each other from the opposite sides of the structural wall. When the outer portion 41 and the inner portion 42 are attached to each other, the at least one input port 6 and the at least one access port 12 are either electrically or electronically attach with each other within the housing 1 completing the system. Then the at least wall attachment 3 is used to secure the second configuration of the present invention with the structural wall as the outer portion 41 secures the inner portion 42. In order to install the third configuration of the present invention, the outer portion 41 and the inner portion 42 are telescopically sleeved into each other from the opposite sides of the structural wall. When the outer portion 41 and the inner portion 42 are attached to each other, the at least one input port 6 and the at least one access port 12 are either electrically or electronically attach with each other within the housing 1 completing the system. Then the at least one wall attachment 3 of the mounting plate 2 and the insertion wall 5 are respectively used to secure the mounting plate 2 and the insertion wall 5 of the third configuration of the present invention with the structural wall.

Because of the easy installation process, the present invention can be installed within many different places, such exterior wall of a building or a house, interior wall of a building or a house, trailers, and motor vehicles. The present invention creates secured environment while resulting cleaner and efficient way to transport electricity or data from one location to another. For example, if the present invention is installed within the exterior wall of a house, electricity can be transported to the inside of the house through the present invention from an electric generator that is located outside, where the present invention completely eliminates electric extension cords running through partially open windows and doors. The present invention can also install within trailer wall so that the electricity or data can be efficiently transported from either inside of the trailer to outside or outside of the trailer to inside without running data cables or extension cords through the trailer doors or windows.

Although the invention has been explained in relation to its preferred embodiment, it is to be understood that many other possible modifications and variations can be made without departing from the spirit and scope of the invention as hereinafter claimed.

What is claimed is:

1. A self contained pre-wired device comprises:
a housing;
at least one input port;
at least one access port;
the housing comprises a mounting plate, a lateral wall, and an insertion wall;
the mounting plate comprises at least one wall attachment;
the mounting plate and the insertion wall being concentrically connected with the lateral wall;
the mounting plate and the insertion wall being oppositely positioned from each other along the lateral wall;
the at least one input port traversing through the mounting plate and being attached onto the mounting plate; and
the at least one access port traversing through the insertion wall and being attached onto the insertion wall.

2. The self contained pre-wired device as claimed in claim 1 comprises:
the insertion wall being positioned flush with the lateral wall;
the mounting plate parameter being larger than the lateral wall parameter; and
the at least one wall attachment being positioned on the mounting plate, wherein the at least one wall attachment secures the housing with a structural wall.

3. The self contained pre-wired device as claimed in claim 1 comprises:
the at least one input port and the at least one access port being electrically connected to each other within the housing.

4. The self contained pre-wired device as claimed in claim 3 comprises:
the at least one input port comprises a female socket with male electrical connectors, a protective cap, and an attachment plate;
the at least one access port comprises a first access port and a second access port;
the attachment plate being adjacently attached with the mounting plate opposite from the lateral wall;
the female socket with male electrical connectors being concentrically positioned on the attachment plate;
the female socket with male electrical connectors traversing into the housing through the mounting plate;
the protective cap being attached onto the attachment plate;
the protective cap being positioned atop the female socket with male electrical connectors;
the first access port and the second access port being traversing into the housing through the insertion wall; and
the female socket with male electrical connectors being electrically connected with the first access port and the second access port.

5. The self contained pre-wired device as claimed in claim 1 comprises:
the at least one input port and the at least one access port being electronically connected to each other within the housing.

6. The self contained pre-wired device as claimed in claim 5 comprises:
the at least one input port comprises a first female socket, a second female socket, a protective cap, and an attachment plate;
the at least one access port comprises a first access port and a second access port;
the attachment plate being adjacently attached with the mounting plate;
the first female socket and the second female socket being positioned on the attachment plate;
the first female socket and the second female socket traversing into the housing through the mounting plate;
the protective cap being pivotally connected onto the attachment plate;
the protective cap being positioned atop the first female socket and the second female socket;
the first access port and the second access port being traversing into the housing through the insertion wall;
the first female socket being electronically connected with the first access port; and
the second female socket being electronically connected with the second access port.

7. A self contained pre-wired device comprises:
a housing;
at least one input port;
at least one access port;
the housing comprises a mounting plate, a lateral wall, and an insertion wall;
the lateral wall comprises an outer portion and an inner portion;
the mounting plate comprises at least one wall attachment;
the mounting plate being concentrically connected with the outer portion;
the insertion wall being concentrically connected with the inner portion;
the outer portion and the inner portion being telescopically engaged with each other;
the outer portion and the inner portion being adjacently positioned with each other in between the mounting plate and the insertion wall;
the at least one input port traversing through the mounting plate and being attached on the mounting plate; and
the at least one access port traversing through the insertion wall and being attached on the insertion wall.

8. The self contained pre-wired device as claimed in claim 7 comprises:
the insertion wall being positioned flush with the inner portion;
the mounting plate parameter being larger than the outer portion parameter; and
the at least one wall attachment being positioned on the mounting plate, wherein the at least one wall attachment secures the housing with a structural wall.

9. The self contained pre-wired device as claimed in claim 7 comprises:
the at least one input port and the at least one access port being electrically connected to each other within the housing.

10. The self contained pre-wired device as claimed in claim 9 comprises:
the at least one input port comprises a female socket with male electrical connectors, a protective cap, and an attachment plate;
the at least one access port comprises a first access port and a second access port;
the attachment plate being adjacently attached with the mounting plate opposite from the lateral wall;
the female socket with male electrical connectors being concentrically positioned on the attachment plate;
the female socket with male electrical connectors traversing into the housing through the mounting plate;
the protective cap being attached onto the attachment plate;
the protective cap being positioned atop the female socket with male electrical connectors;
the first access port and the second access port being traversing into the housing through the insertion wall; and
the female socket with male electrical connectors being electrically connected with the first access port and the second access port.

11. The self contained pre-wired device as claimed in claim 7 comprises:
the at least one input port and the at least one access port being electronically connected to each other within the housing.

12. The self contained pre-wired device as claimed in claim 11 comprises:
the at least one input port comprises a first female socket, a second female socket, a protective cap, and an attachment plate;
the at least one access port comprises a first access port and a second access port;
the attachment plate being adjacently attached with the mounting plate;
the first female socket and the second female socket being positioned on the attachment plate;
the first female socket and the second female socket traversing into the housing through the mounting plate;
the protective cap being attached onto the attachment plate;
the protective cap being positioned atop the first female socket and the second female socket;
the first access port and the second access port being traversing into the housing through the insertion wall;
the first female socket being electronically connected with the first access port; and
the second female socket being electronically connected with the second access port.

13. A self contained pre-wired device comprises:
a housing;
at least one input port;
at least one access port;
the housing comprises a mounting plate, a lateral wall, and an insertion wall;
the lateral wall comprises an outer portion and an inner portion;
the mounting plate and the insertion wall each comprises at least one wall attachment;
the mounting plate being concentrically connected with the outer portion;
the insertion wall being concentrically connected with the inner portion;
the outer portion and the inner portion being telescopically engaged to each other;
the outer portion and the inner portion being adjacently positioned with each other in between the mounting plate and the insertion wall;
the at least one input port traversing through the mounting plate and being attached on the mounting plate; and
the at least one access port traversing through the insertion wall and being attached on the insertion wall.

14. The self contained pre-wired device as claimed in claim 13 comprises:
the insertion wall parameter being lager than the inner portion parameter;
the mounting plate parameter being larger than the outer portion parameter;
the at least one wall attachment being positioned on the mounting plate, wherein the at least one wall attachment secures the outer portion and the mounting plate with a structural wall; and
the at least one wall attachment being positioned on the insertion wall, wherein the at least one wall attachment secures the inner portion and the insertion wall with the structural wall opposite from the outer portion.

15. The self contained pre-wired device as claimed in claim 13 comprises:
the at least one input port and the at least one access port being electrically connected to each other within the housing.

16. The self contained pre-wired device as claimed in claim 15 comprises:
the at least one input port comprises a female socket with male electrical connectors, a protective cap, and an attachment plate;
the at least one access port comprises a first access port and a second access port;
the attachment plate being adjacently attached with the mounting plate opposite from the lateral wall;
the female socket with male electrical connectors being concentrically positioned on the attachment plate;
the female socket with male electrical connectors traversing into the housing through the mounting plate;
the protective cap being attached onto the attachment plate;
the protective cap being positioned atop the female socket with male electrical connectors;
the first access port and the second access port being traversing into the housing through the insertion wall; and
the female socket with male electrical connectors being electrically connected with the first access port and the second access port.

17. The self contained pre-wired device as claimed in claim 13 comprises:
the at least one input port and the at least one access port being electronically connected to each other within the housing.

18. The self contained pre-wired device as claimed in claim 17 comprises:
the at least one input port comprises a first female socket, a second female socket, a protective cap, and an attachment plate;
the at least one access port comprises a first access port and a second access port;
the attachment plate being adjacently attached with the mounting plate;
the first female socket and the second female socket being positioned on the attachment plate;
the first female socket and the second female socket traversing into the housing through the mounting plate;
the protective cap being pivotally connected onto the attachment plate;
the protective cap being positioned atop the first female socket and the second female socket;
the first access port and the second access port being traversing into the housing through the insertion wall;
the first female socket being electronically connected with the first access port; and
the second female socket being electronically connected with the second access port.
